(19) United States
(12) Patent Application Publication
(10) Pub. No.: US 2007/0284939 A1
(43) Pub. Date: Dec. 13, 2007

(54) Aircraft electric brake and generator therefor

(75) Inventors: David L. Charles, South Bend, IN (US); Jonathan T. Beehler, Bremen, IN (US); Roy Lee Kessinger, Greenville, IN (US); John Brian Dempster, Floyds Knobs, IN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, Morris Township, NJ (US)

(21) Appl. No.: 11/450,582

(22) Filed: Jun. 12, 2006

(51) Int. Cl. B60T 8/64

(52) U.S. Cl. 303/152

(57) ABSTRACT

An aircraft braking system includes a brake disk stack (22) that has at least one brake rotor (26) rotatable with an aircraft wheel (16) and at least one brake stator (24), at least one actuator (36) movable in response to a braking command to compress the brake disk stack (22) and slow the wheel (16), at least one actuator motor (32) operably connected to the at least one actuator (36) for moving the at least one actuator (36), a generator (40, 82, 100) having a generator rotor (42) and a generator stator (44), the generator (40, 82, 100) being operably connectable to the aircraft wheel (16) such that said generator rotor (42) rotates when the wheel (16) rotates, and a controller (50) electrically connected to the generator (40, 82, 100) and the at least one actuator motor (32). Also a method of generating electrical power from an aircraft wheel (16).

### FIELD OF THE INVENTION

The present invention is directed to an aircraft electric brake and a generator for powering the electric brake, and to a method of using same, and, more specifically, toward an aircraft electric brake powered by a generator having a generator rotor operably connectable to an aircraft wheel whereby rotation of the wheel rotates the generator rotor and produces power for the electric brake, and to a method of using the generator.

### BACKGROUND OF THE INVENTION

Aircraft brakes often include one or more rotors that rotate with an aircraft wheel and stators fixed with respect to aircraft landing gear which extend between the rotors. The rotors and stators are arranged in an alternating manner to form a brake disk stack and are normally spaced so that the aircraft wheel can rotate freely. When the disk stack is compressed, the rotors and stators are forced into contact which produces friction to slow and stop the wheel.

Various actuators are known for applying a pressure against a disk stack to compress the disk stack. While hydraulic actuators have been used, these are increasingly being replaced by electric actuators that receive power from an aircraft power system and that are controlled by electrical signals from an aircraft control system. Certain known electric actuators include an electric motor, a ram or piston that is moved by the motor toward and away from a disk stack, and a mechanical connection between the motor and the piston to convert the rotary motion of the motor into linear motion of the ram. A ballnut/ballscrew arrangement may be used for this mechanical connection, and the assembly of motor, mechanical connection and piston may be referred to as an electromechanical actuator or “EMA.”

A motor controller receives braking commands from a higher level controller, such as the aircraft's main computer or a braking controller, and controls the current supplied to the motor to control the position of the piston and thus the amount of force applied by the piston against the brake stack. The design and control of electric brakes is discussed, for example, in U.S. Pat. No. 6,471,015 to Ralea, and the entire contents of this reference is hereby incorporated by reference.

Under some circumstances, it may be desirable to operate electric brakes with a high-voltage power supply. However, for safety reasons, which may be the subject of government regulations, for example, it is not always possible or practical to run high-voltage power along a landing gear strut to the brakes. It would therefore be desirable to provide a brake arrangement and method of using same that allows for the provision of high voltage to an aircraft electric brake without running high-voltage cables along an aircraft landing gear strut.

### SUMMARY OF THE INVENTION

This problem and others are addressed by the present invention, a first aspect of which is an aircraft braking system that includes a brake disk stack having at least one brake rotor rotatable with an aircraft wheel, at least one brake stator, at least one actuator movable in response to a braking command to compress the brake disk stack and slow the wheel, and at least one actuator motor operably connected to the at least one actuator for moving the at least one actuator. A generator is also provided that has a generator rotor and a generator stator, and the generator is operably connectable to the aircraft wheel so that the generator rotor rotates when the wheel rotates. A controller is electrically connected to the generator and the at least one actuator motor.

Another aspect of the invention is an aircraft braking system that includes a brake disk stack having a plurality of brake rotors rotatable with an aircraft wheel and a plurality of brake stators projecting between pairs of adjacent rotors, an actuator for compressing the brake disk stack to slow the wheel, and an actuator motor operably connected to the actuator for powering the actuator. A dual mode device is also included which has a device rotor and a device stator, the dual mode device being operable in a first mode as a generator and in a second mode as a motor, the device rotor being operably connectable to an aircraft wheel such that said device rotor rotates when said wheel rotates. A controller is also provided that is electrically connected to the dual mode device and which directs current away from the dual mode device when the dual mode device operates in the first mode. The actuator motor is operably connected to the dual mode device such that the actuator motor is powered by the dual mode device.

An additional aspect of the invention comprises a method of operating an aircraft electric brake having an electric motor that includes steps of providing a generator having a generator rotor, operably connecting the generator rotor to an aircraft wheel such that motion of the wheel turns the generator rotor, electrically connecting an output of the generator to the electric motor, and powering the electric motor with energy produced by the generator.

### BRIEF DESCRIPTION OF THE DRAWINGS

These features and aspects of the invention and others will be better understood after a reading of the following detailed description together with the accompanying drawings, wherein,

FIG. 1 schematically illustrates an aircraft brake system according to a first embodiment of the present invention;

FIG. 2 is a schematic front elevational view of an aircraft brake system according to a second embodiment of the present invention;

FIG. 3 is a schematic side elevational view, partly in section, of the aircraft brake system of FIG. 2; and

FIG. 4 is a schematic side elevational view, partly in section, of an aircraft brake system according to a third embodiment of the present invention.

### DETAILED DESCRIPTION

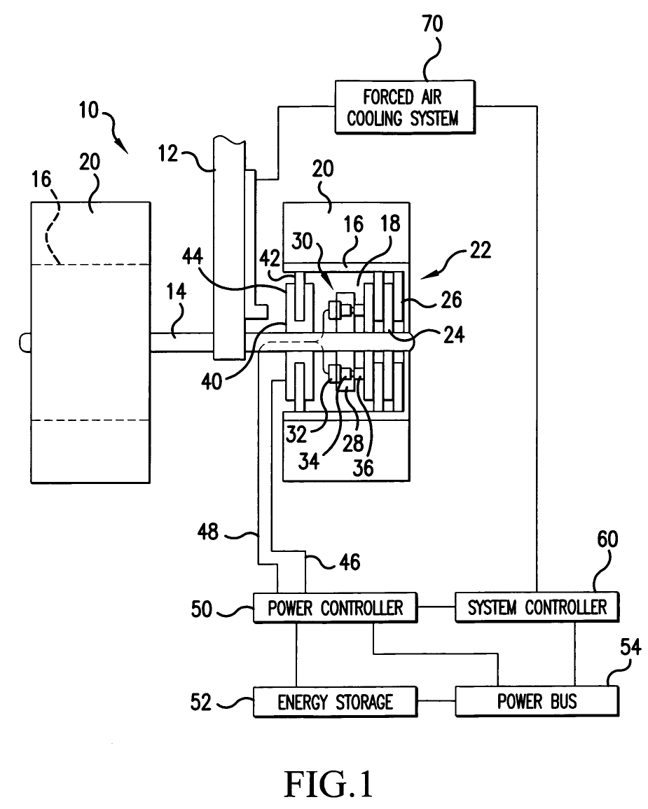

Referring now to the drawings, wherein the showings are for the purpose of illustrating preferred embodiments of the invention only and not for the purpose of limiting same, FIG. 1 schematically illustrates an aircraft landing gear system 10 that includes a strut 12, an axle 14 connected to strut 12, first and second wheels 16 having interiors 18, mounted for rotation about axle 14, and first and second tires 20 mounted on wheels 16. A brake stack 22 is provided in one or each wheel interior 18 and includes a plurality of stators 24 fixed to axle 14 and a plurality of rotors 26 connected to wheel 16 for rotation therewith between pairs of stators 24. An actuator ring 28 is mounted on axle 14 and supports a plurality of electromechanical actuators 30, each of which comprises an electric motor 32, a ballnut/ballscrew assembly 34 and a piston 36.

A generator 40 is also mounted in wheel interior 18 and includes a generator rotor 42 connectable to wheel 16 for rotation therewith and a generator stator 44 connected to axle 14. Thus, as will be appreciated from FIG. 1, the generator rotor 42 rotates relative to the generator stator 44 as wheel 16 rotates, and this causes generator 40 to produce a current on output line 46. While many pancake style axial gap generators could be used, one generator that has useful properties is a segmented electromagnetic array (SEMA) generator such as the one disclosed in U.S. Pat. No. 5,744,896 to Kessinger, the entire contents of which are hereby incorporated by reference.

Output line 46 is connected to power controller 50. Power controller 50 may condition and output the AC current produced by generator 40 and/or may provide commutation to produce the direct current used by many aircraft systems. Beneficially, power controller may provide power to actuators 30 on power lines 48 so that the energy of an aircraft landing can be used to generate the power necessary for braking the aircraft.

Far more energy is produced by a typical landing than is needed to control the aircraft brakes. Therefore, power controller 50 also controls the charging and later discharging of a energy storage device 52. Energy storage device 52 may include one or more batteries; however, batteries may not charge rapidly enough to allow the capture of a substantial portion of the energy generated by an aircraft landing, which may last, for example, on the order of 30 seconds and produce approximately one megawatt of power per wheel. Therefore, energy storage device 52 alternately may comprise a bank of supercapacitors that charge more quickly than presently known batteries and that can absorb all or a substantial amount of the energy produced.

Energy stored in storage device 52 can later be used to provide power to aircraft power bus 54 for general use on an aircraft (not shown) or to actuators 30 when wheels 16 are no longer rotating rapidly enough to produce sufficient energy for controlling actuators 30, when the aircraft has nearly stopped or when the actuators 30 are used to perform a park brake function, for example. A connection to the aircraft power bus 54 provides redundancy and a source of electricity for actuators 30 in addition to the power produced by generator 40. System controller 60 controls power controller 50 and determines how the energy produced by generator 40 is directed and used.

FIG. 1 also illustrates a forced air cooling system 70, which may also be under the control of system controller 60. Forced air cooling of generator 40 allows more efficient operation of the generator 40 and allows for the use of a smaller generator 40 that might be required if no forced air cooling was provided.

Beneficially, generator 40 will function as a motor if current is supplied to the generator 40 on line 46, and generator 40 may therefore sometimes be referred to herein as a dual mode device to emphasize that the device may operate as either a generator or a motor. A generator such as the one disclosed in U.S. Pat. No. 5,744,896, for example, will function as a motor without modification and is an example of such a dual-mode device. Because the generator rotor is coupled to wheel 16, wheel 16 can be caused to rotate by applying power to the dual mode device 40. Therefore, wheels 16 can be pre-rotated prior to landing so that the wheel speed will substantially match the aircraft ground speed at landing to reduce wear on tires 20. Additionally, dual mode device 40 can be used to rotate wheels 16 when the aircraft is on the ground and thus reduce or eliminate the use of aircraft engines for taxiing. Moreover, because system controller 60 can drive the wheels on opposite sides of an aircraft at different speeds, an aircraft can be steered using the main landing gear wheels and reduce or eliminate the need for a separate nose-wheel steering system.

In addition, in the foregoing embodiment, generator 40 is housed in the interior 18 of wheel 16 and power controller 50 may be located on the landing gear assembly as well. With this arrangement, power lines 46 and 48 do not need to run along strut 12 but instead can be kept at the distal end of strut 12 near wheels 16. Various regulations limit the use of high-voltage wiring on an aircraft strut; because power lines 46 and 48 do not run along strut 12, they can carry high voltage without violating these safety rules. This provides greater design flexibility in the design of actuators 30 which may now, if it is desirable, be operated with high voltage.

In operation, when landing gear is deployed prior to landing, power controller 50 sends current to dual mode device 40 to accelerate wheels 16 so that the tires 20 will be rotating at approximately the ground speed of the aircraft when it lands. Shortly before landing, power controller 50 will switch dual mode device 40 into generator mode to convert the forward momentum of the aircraft into usable energy. This energy is then provided to energy storage device 52 and to actuators 30 to compress the brake stack. It will be recognized that the magnetic interaction between the generator rotor and generator stator tends to resist rotation of the aircraft wheel, and therefore the generator itself will provide additional braking for the aircraft. Controller 50 may therefore beneficially take into account the amount of braking force that will be produced by a given generator and thereby reduce the amount of frictional braking force produced by the disk stack 22 so that the total braking force produced by generator action and friction will equal the braking force commanded by a pilot or system controller, with less wear to the consumable (and often expensive) brake rotors and brake stators. A system that uses only a generator for braking is disclosed in U.S. 2005/0224642 to Sullivan, the entire contents of which is hereby incorporated by reference. Various operating methods disclosed in Sullivan may optionally be used in connection with the present invention as well.

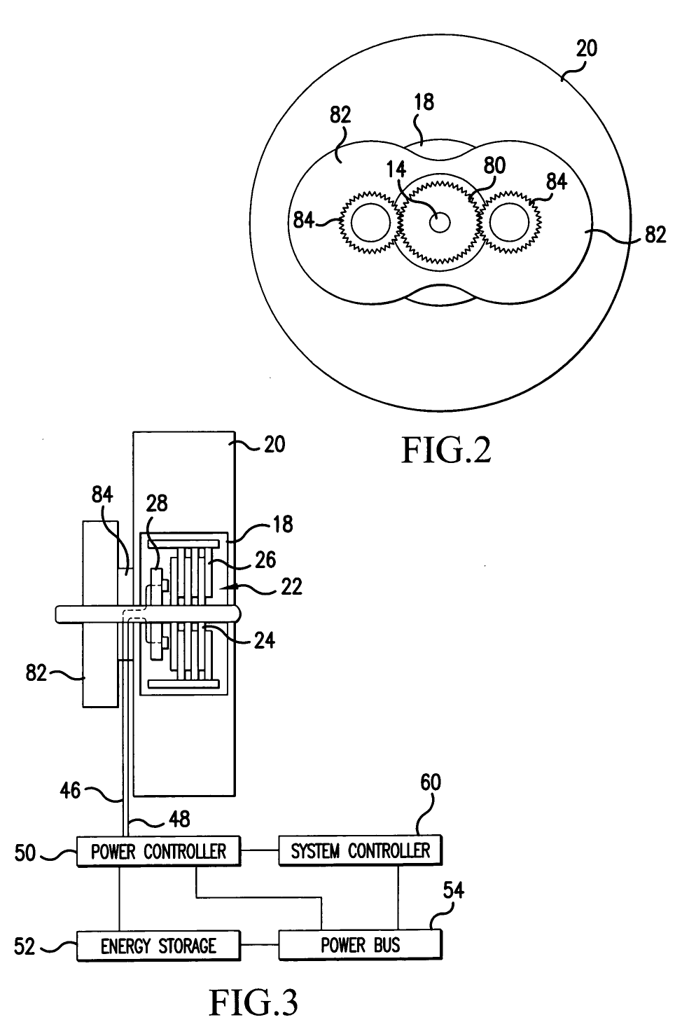

The forgoing embodiment may be useful on wheels and landing gear systems designed to accommodate generator 40 within a wheel interior. However, existing wheels may not be able to accommodate a generator as described above. Therefore, according to a second embodiment of the invention illustrated in FIGS. 2 and 3, one or more generators may be mounted outside wheel 16 and electrically connected to a brake actuator inside the wheel. In this embodiment, elements common to the first embodiment are identified with like reference numerals.

Referring to FIG. 2, a tire 20 is illustrated mounted on a wheel 16 which rotates about the axis of axle 14. A gear 80 is connected to wheel 16 so as to rotate with the wheel, and first and second generators 82 are mounted adjacent wheel 16. Each generator 82 includes a generator gear 84 connected to a generator rotor (not shown), and the generator gears 84 are connected to wheel gear 80 so that the rotation of wheel 16 drives wheel gear 80 and first and second generators 82 to produce an electrical current. Wires 46 connect first and second generators 82 to power controller 50, and wires 48 connect power controller 50 to actuators 30 as in the first embodiment. Wheel 16 can be driven by operating generators 82 in a second mode, as motors, as discussed above in connection with the first embodiment. With this embodiment, two generators can be mounted with rotor axes of rotation offset from the axis of rotation of wheel 16 which provides additional design flexibility. A single generator could also be coaxially mounted with the wheel axis and mounted outside wheel 16 without exceeding the scope of this invention.

As noted above, this arrangement may be useful as a retro-fit for existing aircraft wheels that cannot accommodate a dual-mode device in their interiors. Alternately, this arrangement may be used on smaller aircraft wheels, such as nose wheels. Even if the nose wheels do not include a braking arrangement, the dual-mode device can be useful to generate power for use elsewhere in the aircraft and to operate as a motor and power the nose wheel to reduce or eliminate the need to use aircraft engines for taxiing.

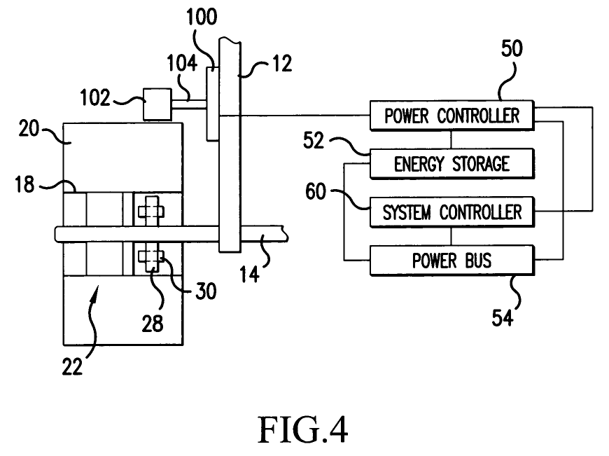

A third embodiment of the invention is illustrated in FIG. 4. In this embodiment, a generator 100 is mounted adjacent to the a wheel, for example on an aircraft strut 12. A friction wheel 102 engages tire 20 and is connected by rod 104 to a rotor (not shown) of generator 100. This arrangement avoids the need to connect a generator directly to a wheel and a simple frictional connection with a tire provides similar benefits to those discussed above. The generator 100 is connected to a power controller 50 and other system elements in the same manner discussed above in connection with the first and second embodiments.

The present invention has been described herein in terms of several preferred embodiments. Obvious additions to and modifications of these embodiments will become apparent to those of ordinary skill in the art upon a reading of the foregoing description, and it is intended that all such obvious additions and modifications form a part of the present invention to the extent that they fall within the scope of the several claims appended hereto.

We claim:

1. An aircraft braking system comprising:
a brake disk stack comprising at least one brake rotor rotatable with an aircraft wheel and at least one brake stator;
at least one actuator movable in response to a braking command to compress the brake disk stack and slow the wheel;
at least one actuator motor operably connected to the at least one actuator for moving the at least one actuator;
a generator having a generator rotor and a generator stator, said generator being operably connectable to the aircraft wheel such that said generator rotor rotates when said wheel rotates; and
a controller electrically connected to said generator and said at least one actuator motor.

2. The aircraft braking system of claim 1 wherein said generator rotor and said at least one brake rotor are coaxially mounted.

3. The aircraft braking system of claim 1 wherein said generator and said brake stack are mounted in the interior of the aircraft wheel.

4. An aircraft braking system comprising:
a brake disk stack comprising a plurality of brake rotors rotatable with an aircraft wheel and a plurality of brake stators projecting between pairs of adjacent rotors;
an actuator for compressing the brake disk stack to slow the wheel;
an actuator motor operably connected to the actuator for powering the actuator;
a dual mode device having a device rotor and a device stator, said dual mode device being operable in a first mode as a generator and in a second mode as a motor, the device rotor being operably connectable to an aircraft wheel such that said device rotor rotates when said wheel rotates; and
a controller electrically connected to said dual mode device and directing current away from said dual mode device when said dual mode device operates in said first mode;
wherein the actuator motor is operably connected to the dual mode device such that said actuator motor is powered by said dual mode device.

5. The aircraft braking system of claim 4 including an energy storage device electrically connected to said dual mode device and to said actuator motor, said controller directing current from said dual mode device to said energy storage device when said dual mode device operates in said first mode and directing current from said energy storage device to said dual mode device when said dual mode device operates in said second mode.

6. The aircraft braking system of claim 4 including a rectifier operably connected to said dual mode device and to said actuator motor.

7. The aircraft braking system of claim 4 wherein said dual mode device comprises a segmented electro-magnetic array device.

8. The aircraft braking system of claim 7 wherein said motor comprises a segmented electro-magnetic array device.

9. The aircraft braking system of claim 5 wherein said energy storage device comprises a supercapacitor.

10. The aircraft braking system of claim 5 wherein said energy storage device comprises a battery.

11. The aircraft braking system of claim 4 wherein said controller directs current to said dual mode device when said dual mode device operates in said second mode.

12. The aircraft braking system of claim 4 wherein said dual mode device and said brake disk stack are mounted inside the aircraft wheel.

13. The aircraft braking system of claim 4 wherein said brake rotor and said dual mode device rotor are coaxially aligned.

14. The aircraft braking system of claim 4 wherein said dual mode device has a first axis of rotation and said generator rotor has a second axis of rotation offset from said first axis of rotation.

15. The aircraft braking system of claim 14 including at least one gear connecting the aircraft wheel to the generator rotor.

16. The aircraft braking system of claim 15 including a second dual mode device operatively connected to said at least one gear.

17. The aircraft braking system of claim 16 wherein said first dual mode device and said second dual mode device are both operably connected to a given one of said at least one gear.

18. A method of operating an aircraft electric brake having an electric motor comprising the steps of:
providing a generator having a generator rotor;
operably connecting the generator rotor to an aircraft wheel such that motion of the wheel turns the generator rotor;
electrically connecting an output of the generator to the electric motor; and
powering the electric motor with energy produced by the generator.

19. The method of claim 18 including the additional steps of:
providing an energy storage device;
operably connecting the energy storage device to the generator; and
charging the energy storage device with the generator.

20. The method of claim 19 including the additional step of:
supplying current from the energy storage device to the generator to cause the generator to function as a motor and drive the aircraft wheel.
